(19) United States
(12) Patent Application Publication
(10) Pub. No.: US 2026/0188651 A1
(43) Pub. Date: Jul. 2, 2026

(54) SILICON ANODE AND BATTERIES MADE THEREFROM

(71) Applicant: Advano, Inc., New Orleans, LA (US)

(72) Inventors: Brandon Dang, Harvey, LA (US); Shiva Adireddy, Metairie, LA (US); Meysam Shahami, Mount Holly, NC (US)

(21) Appl. No.: 19/124,785

(22) PCT Filed: Oct. 26, 2023
(86) PCT No.: PCT/US2023/035984

§ 371 Date: Apr. 25, 2025

Related U.S. Application Data
(60) Provisional application No. 63/419,837, filed on Oct. 27, 2022.

(51) Int. Cl. H01M 4/1395; H01M 4/02; H01M 4/04; H01M 4/133; H01M 4/134; H01M 4/1393; H01M 4/36; H01M 4/38; H01M 4/587; H01M 10/0525

(52) U.S. Cl. CPC H01M 4/1395; H01M 4/0471; H01M 4/133; H01M 4/134; H01M 4/1393; H01M 4/366; H01M 4/386; H01M 4/587; H01M 10/0525; H01M 2004/021; H01M 2004/027

(57) ABSTRACT

A composition useful to make an anode for lithium ion batteries may be made by A method to form particles comprising dispersing an initial powder comprised of silicon in a solvent such as a solvent comprised of a C₅ to C₁₈ aliphatic solvent or polar aprotic aromatic solvent, milling the initial particles to form a milled silicon powder having an average size of about 10 to about 300 nanometers, and depositing the milled silicon powder on a spherical graphite powder having an average size from about 5 to 200 times larger than the average size of the milled silicon powder to form the particles.

### CROSS-REFERENCE TO RELATED APPLICATIONS

This application is a PCT International Application that claims priority to and benefit of U.S. Provisional Application No. 63/419,837, filed on Oct. 27, 2022, the entire disclosures of which are incorporated by reference.

### FIELD

The disclosure relates to a anodes comprised of silicon and batteries made therefrom.

### BACKGROUND

Lithium ion secondary batteries typically have been formed using a metal oxide or metal phosphate particulate cathode and a graphitic particulate anode. Anodes of lithium metal that have higher capacity than graphite have been pursued but have not met with success due to safety concerns such as dendritic growth from the anode that short circuits the battery. Silicon, which has a much higher lithium insertion capacity than graphite (i.e., 4,212 mAh/g versus 372 mAh/g) are being pursued, but have had limited success due to volumetric expansion arising from the insertion of lithium in the silicon structure causing electrical disconnection within the anode reducing the charge capacity substantially.

Accordingly, it would be desirable to provide a method of forming anodes comprised of silicon that avoids one or more of the problems of the art to realize an anode comprised of silicon that has desirable first charge capacity and greater cycle life.

### SUMMARY

A method has been discovered to produce an improved anode comprised of graphite and silicon that has improved first charge capacity and cycle life. A first illustration is a method to form particles comprising: (i) dispersing an initial powder comprised of silicon in a solvent comprised of a first solvent comprised of a C₅ to C₁₈ aliphatic solvent, (ii) milling the initial particles comprised of silicon in the slurry with milling media to form a milled silicon powder comprised of silicon having an average size of about 10 to about 300 nanometers, and (iii) depositing the milled silicon powder on a spherical graphite powder having an average size from about 5 to 200 times larger than the average size of the milled silicon powder to form the particles.

Another illustration of the invention is a composition comprising a spherical graphite coated with a silicon powder having an average size of 10 to about 300 nanometers equivalent spherical diameter, wherein at least a portion of the silicon has bound thereon a solvent, the solvent being a C4 to C18 aliphatic alkane, alkene, alkyne or combination thereof, and the spherical graphite powder having an average size from about 5 to 200 times larger than the average size of the silicon powder to form the particles.

The method and composition are useful as anodes in rechargeable batteries.

### DETAILED DESCRIPTION

Definitions of specific functional groups and chemical terms are described in more detail below. For purposes of this invention, the chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5th Edition, John Wiley & Sons, Inc., New York, 2001; Larock, Comprehensive Organic Transformations, VCH Publishers, Inc., New York, 1989; Carruthers, Some Modern Methods of Organic Synthesis, 3rd Edition, Cambridge University Press, Cambridge, 1987; the entire contents of each of which are incorporated herein by reference.

The terms “halo” and “halogen” as used herein refer to an atom selected from fluorine (fluoro, —F), chlorine (chloro, —Cl), bromine (bromo, —Br), and iodine (iodo, —I). The term “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain atoms, 1-12 carbon atoms, 1-8 carbon atoms, 1-6 carbon atoms, 1-5 carbon atoms, 1-4 carbon atoms, 1-3 carbon atoms, or 1 or 2 carbon atoms. Exemplary aliphatic groups include, but are not limited to, linear or branched, alkyl and alkenyl groups, and hybrids thereof such as (cycloalkyl)allyl, (cycloalkenyl)alkyl or (cycloalkyl)alkenyl. The aliphatic groups may be unsubstituted or substituted. Substituted means that one or more C or H atoms is replaced with oxygen, boron, sulfur, nitrogen, phosphorus or halogen. Typically, one to six carbon atoms may be independently replaced by the aforementioned and in particular oxygen, sulfur or nitrogen. The aliphatic group may have one or more “halo” and “halogen” atoms selected from fluorine (fluoro, —F), chlorine (chloro, —Cl), bromine (bromo, —Br), and iodine (iodo, —I).

If not otherwise specified any characteristic or property may be determined by standard laboratory practices for determining such properties or characteristics.

In an illustration, the method comprises milling silicon in a C₅ to C₁₈ aliphatic solvent to an average size of about 10 to about 300 nm. The particulates of comprised of silicon (also referred to herein as “silicon particulates or silicon powder) may be any suitable silicon useful for making a battery electrode and may be pure silicon (having at most trace amounts of contaminants other than oxygen from the oxidation of the silicon) or an alloy of silicon. For example, the silicon may be a p or n doped silicon or an alloy of silicon such as known in the art. The silicon alloy may be for example, those silicon alloys described by U.S. Pat. Publ. 2017/0338483. Typically, the alloy of silicon has at from any useful amount (10 ppm, 100 ppm, 1%, to 10%, 20% or 30% by weight) of the alloying element such as another Group 14 element (e.g., Ge or Sn), a transition metal or rare earth metal (e.g., aluminum, iron, titanium, chromium, copper, zirconium, titanium, vanadium, manganese, tungsten, niobium, and molybdenum). Any combination of silicon and silicon alloys may make up the initial silicon particulates.

In another illustration, the first solvent may be comprised of an aprotic polar aromatic solvent. Solvent generally means a low molecular weight (typically at most 300 gram/moles, 250 gram/moles or 200 gram/moles). Each of the solvents have essentially no water (e.g., less than 100 ppm, 50 ppm or 20 ppm of water by weight). The aprotic polar aromatic solvent may be substituted within the aromatic ring (e.g., furan) or substituted in a group attached to an atom of the aromatic ring to realize the dipole. For example, the aprotic polar aromatic solvent may be a phenyl substituted with one or more groups containing an O, S, N, or halogen (e.g., anisole), with it being desirable for the substituted group to be a halogen (e.g., F) or N (e.g., fluorobenzene and benzonitrile).

The initial silicon particulates may be derived from an ingots forming the silicon or alloy thereof and may be also be waste silicon (e.g., waste silicon from the processing of silicon wafers). To realize a useful initial silicon particulate to make the that is reduced in size by known wet or dry milling methods to realize a powder that can then be milled to below ˜100 nm (nanometers). That is, a substantial amount of the milled silicon particulates are less than 100 nm as described herein. Typically, the initial silicon particulates have an average size (equivalent spherical diameter) or D50 (median particle size by volume) that is less than 100 μm (micrometers), 50 μm, 25 μm, or 10 μm to about 1 μm or 0.5 μm, generally, the D90 and D10. The milled silicon desirably has the aforementioned particle size and distribution and a specific surface area of 30 m²/g, 40 m²/g, or 50 m²/g to about 200 m²/g, 175 m²/g, or 150 m²/g. Surface area may be determined by the well-known BET (Brunauer-Emmett-Teller) nitrogen adsorption method (e.g., ISO 9277:2010).

The slurry comprised of the initial silicon particles and first solvent may have any useful solids loading. Generally, for the most efficient milling and pumpability, the slurry should have as high a solids loading as possible without having too high a viscosity to avoid, for example, clogging of screens and insufficient agitation of the milling media. Typically, the solids loading of the slurry is at least about 2%, 3% or 4% to 50%, 40%, 35%, 20% or 15% by weight of the initial silicon particulates and solvent. It is understood that if other solid additives are added and milled with the silicon, the solids loading includes all of the solids present in the slurry with aforementioned solids loading ranges being applicable thereto.

When the first solvent is an unsaturated aliphatic C₅ to C₁₈ solvent, which means the solvent is a linear, branched or cyclic alkane that is unsubstituted. Desirably, the first solvent is a straight or branched alkane having from 6 to 12 carbons with examples being hexane, heptane and octane. It may also be desirable to have a second solvent that is comprised of an unsubstituted, branched, linear or cyclic alkene or alkyne with vinyl olefins being particularly useful (e.g, olefins having 5 or 6 carbons to 18, 12, 10 or 8 carbons). Illustratively, the second solvent may be hexene, hexyne, heptene, heptyne, octene, octyne or combination thereof. When the second solvent is present, the amount of first solvent is typically greater than the amount of second solvent by volume and desirably the first solvent and second solvent are present in a volume ratio of first solvent/second solvent of at 0.5, 1, 2, 3 or 4 to 10.

Other additives may be added to the slurry and milled with the initial silicon particulates that may be useful to make an electrode in an electrical device. The additive may be a solid (solid at ambient conditions) that is soluble or insoluble in the solvent. Illustrative additives include, but are not limited to binders, surfactants, porogens, electroconductive materials (e.g., solid electrolytes, carbon and carbon forming materials). The carbon may be any useful carbon that are useful in forming electrodes in batteries and may be amorphous to crystalline (graphitic and any combination thereof). Examples of carbon forming materials include polymers resins and the like that may desirably be dissolved or added as particulates (solid or emulsions) that may be interspersed or adsorbed upon the milled silicon upon removal of the solvent from the milled silicon. Such carbon forming materials may then be pyrolyzed to for carbon when forming a desired electrode or electronic component. Examples of carbon forming compounds may include polymers or resins such as aromatic containing polymers, resins and compounds that form cross-linked thermoset polymers. Illustratively, the carbon forming material may be a polycarbonate, epoxy, polyimide, polyamide, phenol-formaldehyde resin, polyacrylonitrile pitch, carbon pitch (distillation product of coal or oil tar) that has a high molecular weight such as at least 1000 g/moles, 10,000 g/moles, or 20,000 g/moles. When the additive is a solid and does not dissolve at the milling conditions, the solid typically has an average size or D50 size (median by volume) that is within an order of magnitude of the initial silicon particulate average size or D50. Examples of other carbon materials that may be useful in addition to the spherical graphite include graphene, carbon fiber and carbon nanotubes. The amount of the additive may be any useful amount for making an electrode or electronic device from the milled silicon. Illustratively, the amount may be from as little as 0.1% to 90%. Typically, the amount may be from 1%, 2%, 5% or 10% to 75% to 50%, 30% or 25%. When a solid carbon is present, it desirably is present in a volumetric amount such that the volume of silicon particles/carbon particles is from 1/20 or 1/10 to 20 or 10.

The milling may be performed using any suitable method for agitating the milling media sufficiently to yield the desired milled particulates comprised of silicon (“milled silicon”). Illustrative milling methods include, for example, stirred milling, vibratory milling, ultrasonic induced milling, and planetary milling. Suitable milling may be performed in commercially available stirred mills such as those available from Buhler Group (Germany) and Netzsch GmbH (Germany); sonic mills available from Resodyn Corporation. (Butte. MT) and planetary mills available from Glen Mills Inc., (Clifton. NJ) and Retsch GmbH (Germany).

Desirably, the milling media occupies at least 50% by volume of the milling container, but generally, the milling media occupies greater than 75%, 80%, 90% to 95%, 99% or essentially the entire volume so long as the media may still be stirred or agitated. The volume occupied by the milling media is understood to be the bulk volume (i.e., the media and the interstitial porosity between the media).

When milling the initial silicon, the milling media is sufficiently larger than the initial silicon particulates to maximize the milling energy and milling interactions for the most efficient grinding to the desired nanometer scale of the silicon particulates. The milling media average size is at least about 5 to 200 times greater than the initial silicon average particulate size. Desirably, the milling media average size is at least 10 or 20 times to 150, 100 or 75 times larger than the average initial silicon particulate size. Generally, the smallest milling media present should be at least 2, 3 or 5 times the size of the largest initial silicon particulate size. Particles size if not specified otherwise, is the equivalent spherical diameter by volume and may be determined by known sieving, laser light scattering methods or micrographically depending on the size regime of the particulates or milling media. It is also desirable for the milling media to have a narrow size distribution as possible. Illustratively, the milling media the D90 or D100 and D1 or D0 are within 20% or 10% or 5% of the D50 size (by number or volume). Typically, the milling media has an average size or median size from about 1 mm, 500 μm, 300 μm, 250 μm or 150 μm to 25 μm, 30 μm or 50 μm by volume. The milling may be performed in a series of milling steps where larger initial silicon particles are milled with larger milling media and then subsequently be milled with progressively smaller media continuously with multiple mills connected in series or batch (changing the milling media in the same mill for example).

The milling media may be any useful shape such as spherical, ellipsoidal or cylindrical. Desirably, the milling media is spherical. To minimize contamination and efficient milling, the media should be substantially harder than the particulates comprised of silicon. Generally, the milling media has a Vickers hardness (ASTM E384 “micro testing”) is at least 5 GPa. Desirably, the milling media is a ceramic or ceramic metal composite (e.g., WC/Co). The milling media may be any useful ceramic for milling the silicon without causing deleterious contamination. The ceramic milling media may be comprised of silicon such as carbides, nitrides, oxides or combinations thereof of silicon. Desirably, the density of the milling media is greater than the silicon particulates and generally is at least about 2.5 g/cc, 3 g/cc, 4 g/cc to 10 g/cc. Examples of milling media include those comprised of zirconium such as cubic stabilized zirconia (e.g., stabilized with one or more of Mg, Ca, Y, Ce, Al and Hf), zircon, silicon carbide, WC/Co, mixed carbides such as those described in U.S. Pat. No. 5,563,107 and WO 2004/110699, incorporated herein by reference. Cubic stabilized zirconia milling media that are suitable may be obtained from Chemco Advanced Material (Suzhou) Co., Ltd., China.

The milling may be performed for any length of time suitable to form the milled silicon having an average size of 10 nm to 300 nm and may depend on the initial silicon particulate size and as required multiple milling steps as described previously. Typically, the amount of time is from about 1 hour to 48 hours and may be continuously applied or intermittent. The temperature may be any useful temperature and may, for example, depend on the particular first solvent used. The heating or cooling may be accomplished by know methods of cooling such as water jackets and heating tapes on the exterior of the mill.

The milled silicon has an average size of 10 nm to 300 nm. Typically, the average size is about 20 nm, 40 nm or 50 nm to 250 nm, 200 nm, 150 nm or 100 nm. Illustratively, the particle size distribution may be such that the milled silicon powder has a D90 or D100 of less than 300 nm, 250 nm or 200 nm or 150 nm and a DO or 10 greater than 5 nm, 10 nm, 20 nm, 30 nm, 40 nm or 50 nm with a D50 being with the aforementioned range and generally from about 150 nm or 125 nm to about 50 nm, 60 nm, 70 nm or 80 nm.

The milled silicon is deposited upon spherical graphite particles that having an average size of at least 5 to 200 times larger than the average size of the milled silicon particles. The spherical graphite, typically, has an average size of from about 5 μm or 10 μm to about 50 μm or 25 μm. It is understood that the spherical graphite is not perfectly spherical but may be ovoid in nature and are not flakes. The spherical graphite, generally, has a high purity such as at least 99.95% pure, but may also be comprised of a small amount of oxides such as silica, titania and zirconia (e.g., less than 5% or 1% by volume). The spherical graphite may be from artificial graphite or purified natural graphite. Examples of useful spherical graphics are described in U.S. Pat. Pub. US20160141603A1, incorporated herein by reference. Examples of suitable commercially available spherical graphites include those available from Syrah Resources, Magnis Resources, Northern Graphite, Focus Graphite and Graphite One.

The milled silicon may be deposited upon the spherical graphite by any suitable method such as those known in the art. Illustratively, the silicon after separating from the milling media may be mixed with the spherical graphite and the solvent removed realizing the deposition of the milled silicon on to the spherical graphite. The removal of the solvent may be by any suitable process of removing the milling solvent such as drying using heating including for example spray drying. When the second solvent is present, it has been surprisingly found that second solvent may be bound to a portion of the milled silicon powder. The amount of silicon powder/spherical graphite is from 0.05 to 2 by volume and desirably is from 0.1 or 0.2 to 1, or 0.5. The mixing of the spherical carbon is desirably at a shear rate that fails to attrit or reduce the particle size of the spherical graphite. For example, simple paddle mixing is sufficient. Fails to attrit the spherical graphite means that the mixing is done such that the surface area of the spherical graphite increases in specific surface area by at most about 10% or 5%. The milling of the silicon and mixing with the spherical graphite desirably is done in the absence of a surfactant to avoid contamination.

If desired, such as when the milled silicon deposited on the spherical graphite has a carbon forming additive such as pitch, the silicon coated spherical powder may be heated further under conditions suitable to carbonize the carbon forming additive. Typically, temperature of greater than about 400° C. to 1000° C. may be used under inert or reducing atmospheres for any suitable time at temperature such as 10 minutes, 30 minutes, 60 minutes to 24 hours, 12 hours, 6 hours or 2 hours. The reducing atmosphere may be static or flowing and may include noble gases, nitrogen, reducing gases (e.g., syn gas, hydrogen and carbon monoxide) or combinations thereof.

### ILLUSTRATIVE EMBODIMENTS

Embodiment 1. A method to form particles comprising:
   (i) dispersing an initial powder comprised of silicon in a solvent comprised of a first solvent comprised of a C₅ to C₁₈ aliphatic solvent,
   (ii) milling the initial particles comprised of silicon in the slurry with milling media to form a milled silicon powder comprised of silicon having an average size of about 10 to about 300 nanometers, and
   (iii) depositing the milled silicon powder on a spherical graphite powder having an average size from about 5 to 200 times larger than the average size of the milled silicon powder to form the particles.
Embodiment 2. The method of embodiment 1, the milled silicon powder is present in an amount and the spherical graphite is present in an amount, wherein the amount of silicon powder to the amount spherical graphite powder is a volumetric ratio of about 0.05 to 2.
Embodiment 3. The method of embodiment 2, wherein the volumetric ratio is 0.1 to 1.
Embodiment 4. The method of any one of the preceding embodiments, wherein the solvent is comprised of a second alkene or alkyne solvent.
Embodiment 5. The method any one of the preceding embodiments, wherein the second solvent and first solvent are present in amounts such that the amount of first solvent and second solvent are at a solvent ratio of at least 0.5.
Embodiment 6. The method of embodiment 5, wherein the solvent ratio is from 10/1 to 1/1.
Embodiment 7. The method of any one of the preceding embodiments, wherein the first solvent is a straight chain alkane having 6 to 12 carbons.
Embodiment 8. The method of embodiment 7, wherein first solvent has a molecular weight of at most about 250 g/moles.
Embodiment 9. The method of any one of embodiments 4 to 8, wherein the second solvent is comprised of an alkyne.
Embodiment 10. The method of either embodiment 17 or 18, wherein the milling media is comprised of an oxide, carbide, nitride or combination thereof.
Embodiment 11. The method of any one of the preceding embodiments wherein the depositing is by mixing the spherical graphite with the milled silicon powder in a liquid to form a mixture and removing the liquid.
Embodiment 12. The method of embodiment 11, wherein the liquid is comprised of the second solvent.
Embodiment 13. The method of embodiment 12, wherein the mixing is performed without attriting the spherical graphite.
Embodiment 14. The method of any one of the preceding embodiments wherein the initial powder comprised of silicon are silicon, alloy of silicon or combination thereof.
Embodiment 15. The method of embodiment 14, wherein the alloy of silicon is comprised of at least 50% by weight of silicon and at least one of the following elements: aluminum, iron, titanium, chromium, copper, zirconium, titanium, vanadium, manganese, tungsten, niobium, and molybdenum.
Embodiment 16. The method of any one of the preceding embodiments wherein the milled silicon powder has a specific surface area of at least 40 m²/g.
Embodiment 17. The method of embodiment 16, wherein the surface area is at least about 50 m²/g.
Embodiment 18. The method any one of the preceding embodiments wherein the milled silicon powder has a D₁₀ of 5 nanometers (nm) to 50 nm, D₅₀ of 50 nm to 150 nm and D₉₀ of 300 nm to 100 nm.
Embodiment 19. The method of any one of the preceding embodiments, wherein the slurry is further comprised of an additive.
Embodiment 20. The method of embodiment 19, wherein the additive is carbon or carbon forming compound.
Embodiment 21. The method of either embodiment 19 or 20, wherein the slurry is in the absence of a surfactant.
Embodiment 22. The method of any one of embodiments 19 to 21, wherein the carbon forming compound is a high molecular weight compound comprised of aromatic groups.
Embodiment 23. The method of embodiment 22, wherein the carbon forming compound is a pitch.
Embodiment 24. The method of embodiment 20, wherein the carbon is comprised of one or more of a carbon fiber, carbon nanotube and graphene.
Embodiment 25. The method of any one of the preceding embodiments, wherein the solvent is removed at conditions where the the solvent evaporates to form a dried milled silicon powder having bonded thereto the first solvent.
Embodiment 26. The method of embodiment 25, wherein the removing is performed by spray drying.
Embodiment 27. The method of embodiment 25, wherein the dried milled silicon powder is heated to a temperature under a reducing atmosphere forming pyrolyzed particles.
Embodiment 28. The method of embodiment 26, wherein the reducing atmospheric is comprised of one or more of carbon monooxide and hydrogen.
Embodiment 29. The method of embodiment 27, further comprising depositing the pyrolyzed particles onto a metal sheet to form an electrode.
Embodiment 30. The method embodiment 29, wherein the electrode is comprised of an additive.
Embodiment 31. The method of embodiment 30, wherein the additive is a polymeric binder.
Embodiment 32. The method of any one of embodiments 29 to 31, further comprising forming a battery with the electrode.
Embodiment 33. A composition comprising a spherical graphite coated with a silicon powder having an average size of 10 to about 300 nanometers equivalent spherical diameter, wherein at least a portion of the silicon has bound thereon a solvent, the solvent being a C4 to C18 aliphatic alkane, alkene, alkyne or combination thereof, and the spherical graphite powder having an average size from about 5 to 200 times larger than the average size of the silicon powder to form the particles.
Embodiment 34. The composition of embodiment 33, wherein the silicon and spherical graphite are each present in an amount where the amount of silicon to spherical graphite is a volumetric ratio of about 0.05 to 2.
Embodiment 35. The composition of embodiment 33, wherein the volumetric ratio is about 0.1 to 1.
Embodiment 36. The composition of any one of embodiments 33 to 35 wherein the composition is further comprised of an other solid particulate comprised of carbon.
Embodiment 37. The composition of embodiment 36, wherein the other solid particulate of carbon is comprised of one or more of a carbon nanotube, carbon fiber and graphene.
Embodiment 38. The composition of embodiment 37, wherein the other solid particulate of carbon is the carbon nanotube.
Embodiment 39. The composition of any one of embodiments 36 to 38, wherein the other solid particulate is present in an amount of about 0.05% to 2% by weight of the composition.
Embodiment 40. A method to form particles comprising:
   (i) dispersing an initial powder comprised of silicon in a solvent comprised of a first solvent comprised of an aprotic polar aromatic solvent,
   (ii) milling the initial particles comprised of silicon in the slurry with milling media to form a milled silicon powder comprised of silicon having an average size of about 10 to about 300 nanometers, and
   (iii) depositing the milled silicon powder on a spherical graphite powder having an average size from about 5 to 200 times larger than the average size of the milled silicon powder to form the particles.
Embodiment 41. The method of embodiment 40, the milled silicon powder is present in an amount and the spherical graphite is present in an amount, wherein the amount of silicon powder to the amount spherical graphite powder is a volumetric ratio of about 0.05 to 2.
Embodiment 42. The method of embodiment 41, wherein the volumetric ratio is 0.1 to 1.
Embodiment 43. The method of any one of embodiment 40 to 42, wherein the aprotic polar aromatic solvent is has a substituent comprised of nitrogen, halogen or combination thereof.
Embodiment 44. The method of embodiment 43, wherein the aprotic polar aromatic solvent is benzonitrile.
Embodiment 45. The method of any one of the preceding embodiments wherein the depositing is by mixing the spherical graphite with the milled silicon powder in a liquid to form a mixture and removing the liquid.
Embodiment 46. The method of embodiment 45, wherein the mixing is performed without attriting the spherical graphite.
Embodiment 47. The method of any one of embodiment 40 to 46 wherein the initial powder comprised of silicon are silicon, alloy of silicon or combination thereof.
Embodiment 48. The method of embodiment 47, wherein the alloy of silicon is comprised of at least 50% by weight of silicon and at least one of the following elements: aluminum, iron, titanium, chromium, copper, zirconium, titanium, vanadium, manganese, tungsten, niobium, and molybdenum.
Embodiment 49. The method of any one of embodiments 40 to 48 wherein the milled silicon powder has a specific surface area of at least 40 m²/g.
Embodiment 50. The method any one embodiments 40 to 49 wherein the milled silicon powder has a D₁₀ of 5 nanometers (nm) to 50 nm, D₅₀ of 50 nm to 150 nm and D₉₀ of 300 nm to 100 nm.
Embodiment 51. The method of any one of embodiments 40 to 50, wherein the slurry is further comprised of an additive.
Embodiment 52. The method of embodiment 51, wherein the additive is carbon or carbon forming compound.
Embodiment 53. The method of either embodiment 51 or 52, wherein the slurry is in the absence of a surfactant.
Embodiment 54. The method of any one of embodiments 51 to 53, wherein the carbon forming compound is a high molecular weight compound comprised of aromatic groups.
Embodiment 55. The method of embodiment 54, wherein the carbon forming compound is a pitch.
Embodiment 56. The method of embodiment 52, wherein the carbon is comprised of one or more of a carbon fiber, carbon nanotube and graphene.
Embodiment 57. The method of any one of embodiments 40 to 56, wherein the solvent is removed at conditions where the solvent evaporates to form a dried milled silicon powder having bonded thereto the first solvent.
Embodiment 58. The method of embodiment 57, wherein the removing is performed by spray drying.
Embodiment 59. The method of embodiment 57, wherein the dried milled silicon powder is heated to a temperature under a reducing atmosphere forming pyrolyzed particles.
Embodiment 60. The method of embodiment 59, wherein the reducing atmosphere is comprised of one or more of carbon monooxide and hydrogen.
Embodiment 61. The method of embodiment 60, further comprising depositing the pyrolyzed particles onto a metal sheet to form an electrode.
Embodiment 62. The method embodiment 61, wherein the electrode is comprised of an additive.
Embodiment 63. The method of embodiment 62, wherein the additive is a polymeric binder.
Embodiment 64. The method of any one of embodiments 62 to 63, further comprising forming a battery with the electrode.
Embodiment 65. A composition comprising a spherical graphite coated with a silicon powder having an average size of 10 to about 300 nanometers equivalent spherical diameter, wherein at least a portion of the silicon has bound thereon a solvent, the solvent being an aprotic polar aromatic solvent, and the spherical graphite powder having an average size from about 5 to 200 times larger than the average size of the silicon powder to form the particles.
Embodiment 66. The composition of embodiment 65, wherein the silicon and spherical graphite are each present in an amount where the amount of silicon to spherical graphite is a volumetric ratio of about 0.05 to 2.
Embodiment 67. The composition of embodiment 65, wherein the volumetric ratio is about 0.1 to 1.
Embodiment 68. The composition of any one of embodiments 65 to 67 wherein the composition is further comprised of an other solid particulate comprised of carbon.
Embodiment 69. The composition of embodiment 68, wherein the other solid particulate of carbon is comprised of one or more of a carbon nanotube, carbon fiber and graphene.
Embodiment 70. The composition of embodiment 69, wherein the other solid particulate of carbon is the carbon nanotube.
Embodiment 71. The composition of any one of embodiments 68 to 70, wherein the other solid particulate is present in an amount of about 0.05% to 2% by weight of the composition.

### EXAMPLES

In each of the Examples 1-10 and Comparative Examples 14, silicon is dry milled and sieved to less than 60 micrometers to form an initial silicon having an average particles size 6-54 micrometer with no particles greater than 60 micrometers. The initial silicon is added to the solvent shown in Table 1 having a water concentration of about 1500 ppm by weight to form a slurry having ˜13% % by weight silicon solids. The slurry is milled using a Buhler MMX1 (Switzerland) where the milling chamber is filled with 100 micrometer yittria stabilized milling media sphere available from Switzerland. The milling chamber is filled to about 85% by the milling media. The mill is run at 1600 RPM (revolutions per minute) and the speed is maintained at above 14 meters/second. Table 1 shows the particle size and surface area after ˜7000 kWh/MT (kilowatt-hours/metric ton) of milling input energy. The particle size is determined by scanning electron microscopy. The surface area is determined by BET nitrogen adsorption and is shown in Table 1. Each of the silicon powders are mixed with spherical carbon as shown in Table 2. After mixing these components, they are spray dried under the same conditions and then heated under a reducing atmosphere at 1000° C. subsequently. The carbonized spray dried particles (80% by weight) are mixed with 10% polyacrylic acid by weight and balance Timcal C45 carbon in NMP (n-methylpyrrolidone), which is cast onto a copper foil and made into half coin cells. Each of the Examples is tested in the same manner with a 0.3C rate. From the data, Examples 1 to 4 having hexane as the first solvent and hexyne as the second solvent perform better than the corresponding Comparative Examples. Examples 5 to 8, likewise perform better than the corresponding Comparative Examples, but not as well as Examples 1 to 4

TABLE 1

| | | | Surface | D10 Particle | D50 Particle | D90 Particle |
|---|---|---|---|---|---|---|
| Examples | Milling Solvents | | Area (m²/g) | size (nm) | size (nm) | size (nm) |
| 1 to 4 | 15% | 85% | 49.39 | 113.8 ± 13.2 | 211.0 ± 8.8 | 350.3 ± 33.7 |
| | Hexyne | Hexane | | | | |
| 5 to 8 | | 100% | 49.73 | 122.0 ± 3.3 | 196.0 ± 2.8 | 342.0 ± 26.8 |
| | | Hexane | | | | |
| 9 and 10 | | 100% | Not | Not | Not | Not |
| | | Benzonitrile | measured | measured | measured | measured |
| C. 1 to 4 | 15% | 85% | 52.07 | 104.5 ± 10.8 | 169.0 ± 2.8 | 316.5 ± 27.9 |
| | Hexyne | Toluene | | | | |

TABLE 2

| | | | | Spherical | Carbon | | Expected | Initial | | Cycle |
|---|---|---|---|---|---|---|---|---|---|---|
| | | | Si | Graphite | Nanotube | Pitch | Capacity | Capacity | FCE | Ret. @ |
| Ex. | Milling Solvents | | (wt %) | (wt %) | (wt %) | (wt %) | (mAh/g) | (mAh/g) | (%) | 20 cyc. |
| 1 | 15% Hexyne | 85% Hexane | 33 | 42 | 0 | 25 | 1367 | 1373 | 90.2 | 45.38 |
| 2 | 15% Hexyne | 85% Hexane | 32.9 | 42 | 0.1 | 25 | 1357 | 1253 | 89.7 | 66.08.7 |
| 3 | 15% Hexyne | 85% Hexane | 32.9 | 22 | 0.1 | 25 | 2304 | 1851 | 89.1 | 27.37 |
| 4 | 15% Hexyne | 85% Hexane | 32.9 | 62 | 0.1 | 25 | 740 | 744 | 89.1 | 93.4 |
| 5 | | 100% Hexane | 33 | 42 | 0 | 25 | 1517 | 1308 | 88.6 | 40.46 |
| 6 | | 100% Hexane | 32.9 | 42 | 0.1 | 25 | 1472 | 1411 | 88.7 | 47.77 |
| 7 | | 100% Hexane | 32.9 | 22 | 0.1 | 25 | 2040 | 1882 | 88.9 | 35.01 |
| 8 | | 100% Hexane | 32.9 | 62 | 0.1 | 25 | 1079 | 911 | 87.6 | 86.40 |
| 9 | | 100% Benzonitrile | 32.9 | 42 | 0.1 | 25 | 1550 | 1323 | 84.7 | 85.9 |
| 10 | | 100% Benzonitrile | 32.9 | 62 | 0.1 | 25 | 1100 | 880 | 84.7 | 98.2 |
| C.1 | 15% Hexyne | 85% Toluene | 33 | 42 | 0 | 25 | 1600 | 1522 | 88.9 | 50.34 |
| C.2 | 15% Hexyne | 85% Toluene | 32.9 | 42 | 0.1 | 25 | 1600 | 1424 | 88 | 39.15 |
| C.3 | 15% Hexyne | 85% Toluene | 32.9 | 22 | 0.1 | 25 | 2200 | 1886 | 87.4 | 15.73 |
| C.4 | 15% Hexyne | 85% Toluene | 32.9 | 62 | 0.1 | 25 | 1000 | 1091 | 88.3 | 70.52 |

Carbon Nanotube: TUBALL graphene nanotubes
Pitch: Rain Carbon Inc. ZL250

1. A method to form particles comprising:
(i) dispersing an initial powder comprised of one or more of pure silicon, a silicon metal alloy or combination thereof in a solvent comprised of a first solvent comprised of a C₅ to C₁₈ aliphatic solvent to form a slurry,
(ii) milling the initial particles comprised of silicon in the slurry with milling media to form a milled silicon powder comprised of silicon having an average size of about 10 to about 300 nanometers, and
(iii) depositing the milled silicon powder on a spherical graphite powder having an average size from about 5 to 200 times larger than the average size of the milled silicon powder to form the particles.

2. The method of claim 1, the milled silicon powder is present in an amount and the spherical graphite is present in an amount, wherein the amount of silicon powder to the amount spherical graphite powder is a volumetric ratio of about 0.05 to 2.

3. The method of claim 2, wherein the volumetric ratio is 0.1 to 1.

4. The method of claim 3, wherein the solvent is comprised of a second alkene or alkyne solvent and is not a halogenated solvent.

5. The method of claim 4, wherein the second solvent and first solvent are present in amounts such that the amount of first solvent and second solvent are at a solvent ratio of at least 0.5.

6. (canceled)

7. (canceled)

8. (canceled)

9. The method of claim 4, wherein the second solvent is comprised of an alkyne or alkene that is cyclic, linear, or branched and unsubstituted.

10. (canceled)

11. The method of claim 1, wherein the depositing is by mixing the spherical graphite with the milled silicon powder in a liquid to form a mixture and removing the liquid.

12. The method of claim 1, wherein the milled silicon powder has a specific surface area of at least 40 m²/g.

13. (canceled)

14. The method of claim 12, wherein the milled silicon powder has a D₁₀ of 5 nanometers (nm) to 50 nm, D₅₀ of 50 nm to 150 nm and D₉₀ of 300 nm to 100 nm.

15. (canceled)

16. The method of claim 1, wherein the solvent is removed at conditions where the solvent evaporates to form a dried milled silicon powder having bonded thereto the first solvent.

17. The method of claim 16, wherein the dried milled silicon powder is heated to a temperature under a reducing atmosphere forming pyrolyzed particles.

18. The method of claim 17, wherein the reducing atmosphere is comprised of one or more of carbon monoxide and hydrogen.

19. A composition comprising comprised of particles comprising a spherical graphite coated with a silicon powder comprising one or more of pure silicon, a silicon alloy, or a combination thereof having an average size of 10 to about 300 nanometers equivalent spherical diameter, wherein at least a portion of the silicon has bound thereon a solvent, the solvent being a C4 to C18 aliphatic alkane, alkene, alkyne or combination thereof, and the spherical graphite powder having an average size from about 5 to 200 times larger than the average size of the silicon powder to form the particles.

20. The composition of claim 19, wherein the composition is further comprised of an other solid particulate comprised of carbon.

21. The composition of claim 20, wherein the other solid particulate of carbon is comprised of one or more of a carbon nanotube, carbon fiber and graphene.

22. (canceled)

23. A method to form particles comprising:
(i) dispersing an initial powder comprised of one or more of pure silicon, a silicon alloy, or a combination thereof in a solvent comprised of a first solvent comprised of an aprotic polar aromatic solvent to form a slurry,
(ii) milling the initial particles comprised of silicon in the slurry with milling media to form a milled silicon powder comprised of silicon having an average size of about 10 to about 300 nanometers, and
(iii) depositing the milled silicon powder on a spherical graphite powder having an average size from about 5 to 200 times larger than the average size of the milled silicon powder to form the particles.

24. The method of claim 23, the milled silicon powder is present in an amount and the spherical graphite is present in an amount, wherein the amount of silicon powder to the amount spherical graphite powder is a volumetric ratio of about 0.05 to 2.

25. The method of claim 24, wherein the aprotic polar aromatic solvent has a substituent comprised of nitrogen, halogen or combination thereof.

26. The method of claim 25, wherein the aprotic polar aromatic solvent is benzonitrile.

27. The method of claim 1 wherein the depositing is by mixing the spherical graphite with the milled silicon powder in a liquid to form a mixture and removing the liquid.

28. The method of claim 27, wherein the mixing is performed without attriting the spherical graphite.

29. The method of claim 23, wherein the slurry is in the absence of a surfactant.

30. A composition comprising particles comprised of a spherical graphite coated with a silicon powder having an average size of 10 to about 300 nanometers equivalent spherical diameter, wherein at least a portion of the silicon has bound thereon a solvent, the solvent being an aprotic polar aromatic solvent, and the spherical graphite powder having an average size from about 5 to 200 times larger than the average size of the silicon powder to form the particles.

31. The composition of claim 30, wherein the silicon and spherical graphite are each present in an amount where the amount of silicon to spherical graphite is a volumetric ratio of about 0.05 to 2.

32. The composition of claim 31, wherein the composition is further comprised of an other solid particulate comprised of carbon.

33. (canceled)

34. The composition of claim 30, wherein the aprotic polar aromatic solvent comprises benzonitrile.
